(19) United States
(12) Patent Application Publication
(10) Pub. No.: US 2001/0049602 A1
(43) Pub. Date: Dec. 6, 2001

(54) Method and system for converting text into speech as a function of the context of the text

(76) Inventors: David L. Walker, Tucson, AZ (US); Mark G. Mackelprang, Tucson, AZ (US); Andrew J. Sipe, Tucson, AZ (US); Armand C. Sperduti, Tucson, AZ (US)

Correspondence Address: James N. Kallis, Brooks & Kushman P.C., 1000 Town Center, 22nd Floor, Southfield, MI, 48075-1351, US

(21) Appl. No.: 09/852,489

(22) Filed: May 10, 2001

Related U.S. Application Data
(60) Provisional application No. 60/205,000, filed on May 17, 2000.

(51) Int. Cl. G10L 13/08; G10L 13/00

(52) U.S. Cl. 704/260

(57) ABSTRACT

A communication system for communicating information to a telephone user in response to a request for the information from the telephone user. The communication system includes a text data source having text documents. A voice application receives a request from the telephone user for information and then retrieves a text document related to the requested information from the text data source. A context detector determines the context of the text document. A text cleaner modifies the text document as a function of a context of the text document. A text-to-speech (TTS) converter converts the modified text document into speech. The TTS converter provides the speech to the telephone user via the voice application in order to satisfy the request for information from the telephone user.

### CROSS-REFERENCE TO RELATED APPLICATIONS

This application claims the benefit of U.S. Provisional Application No. 60/205,000 filed May 17, 2000.

### TECHNICAL FIELD

The present invention is generally related to text-to-speech conversion methods and systems and, more particularly, to a text-to-speech method and system which convert written text into audible speech as a function of the context of the text.

### BACKGROUND ART

Text-to-speech (TTS) engines are computing devices which convert written text into audible computer generated speech. The direct translation of the written word to the spoken word is usually not a smooth process. Given text from an email message, news story, web page, or any other text data source, TTS engines do their best to synthesize the written words of a text document into computer generated speech understandable by humans. However, the result is often an unnatural speech delivery because of the diversity and context of written words. Even small speech differences in what humans are accustomed to in normal conversation can cause large differences in how humans perceive the quality and naturalness of computer generated speech.

TTS engines are general purpose tools which deal with text processing in a general way and do not perform satisfactorily when presented with out of the ordinary text. For instance, if a document containing the text “10-5” is processed by a TTS engine, the TTS engine must make a decision on how to translate the text “10-5” to speech, i.e., how to say “10-5”. A problem is that the TTS engine does not know the context of the document containing the text “10-5”. As a result, the TTS engine converts the text “10-5” to speech having the highest chance of being correct and perhaps pronounces “ten minus five.” The text “10-5” may be correctly or incorrectly pronounced as “ten minus five” depending on the context of the document. For instance, if the context of the document is mathematics then the text “10-5” would be correctly pronounced as “ten minus five.” However, if the context of the document is sports such as a sports score then the text “10-5” should be pronounced as “ten to five” or “ten dash five” if the context of the document pertains to legal rules. Without knowing the context of the document, the TTS engine may incorrectly convert the text “10-5” into speech.

As another example, the text “wind” may need to be converted into speech. The text “wind” may be phonetically pronounced as either “wind” or “wind” depending on the context of the document. For instance, if the context of the document is weather then the text “wind” should be pronounced as “wind.” However, if the context of the document is directed to time then the text “wind” should be pronounced as “wind” such as used in the phrase “wind the clock.” Again, without knowing the context of the document, the TTS engine may incorrectly convert the text “wind” into speech.

### DISCLOSURE OF INVENTION

Accordingly, it is an object of the present invention to provide a text-to-speech (TTS) method and system which convert written text into audible speech as a function of the context of the text.

It is another object of the present invention to provide a method and system for using a contextual analysis of text to enhance the quality of a TTS conversion of the text into speech.

It is a further object of the present invention to provide a method and system for preprocessing text based on its application context prior to the text being converted into speech by a TTS engine.

It is still another object of the present invention to provide a method and system for converting raw text into cleaned text by modifying the raw text in accordance with its context and then converting the cleaned text into speech.

It is still a further object of the present invention to provide a method and system for retrieving text from a text source in response to a request for the text from a telephone user, determining the context of the text using context detection rules, modifying the text in accordance with text cleaning rules associated with the determined context, converting the modified text into speech, and then streaming the speech to the telephone user to satisfy the request for the text from the telephone user.

In carrying out the above objects and other objects, the present invention provides a system for converting text into speech. The system includes a text cleaner operable for modifying text as a function of a context of the text and a TTS converter operable with the text cleaner for converting the modified text into speech. The system may include a context detector operable for detecting the context of the text. The context detector is operable with the text cleaner for providing information indicative of the context of the text to the text cleaner.

The system may include a context detection rules database operable for storing context detection rule sets. Each context detection rule set is associated with a context. The context detector is operable with the context detection rules database for applying the context detection rule sets to the text in order to detect the context of the text. The system may further include a rules manager operable for enabling an administrator to generate context detection rule sets. The rules manager is operable with the context detection rules database for storing the generated context detection rule sets in the context detection rules database.

The system may also include a text cleaning rules database operable for storing text cleaning rule sets each associated with a context. The text cleaner is operable with the text cleaning rules database for accessing the text cleaning rule sets in order to modify the text in accordance with the text cleaning rule sets associated with the context of the text. The system may further include a rules manager operable for enabling an administrator to generate text cleaning rule sets. The rules manager is operable with the text cleaning rules database for storing the generated text cleaning rule sets in the text cleaning rules database. The text cleaner may be operable for modifying the text as a function of multiple contexts of the text.

Further, in carrying out the above objects and other objects, the present invention provides a method associated with the system for converting text into speech. The method includes detecting a context of the text, modifying the text as a function of the context of the text, and converting the modified text into speech.

Also, in carrying out the above objects and other objects, the present invention provides a communication system for communicating information to a telephone user in response to a request for the information from the telephone user. The communication system includes a text data source having a plurality of text documents and a voice application operable with the telephone user for receiving a request from the telephone user for information. The voice application is operable with the text data source for retrieving a text document related to the information requested by the telephone user. A text cleaner is operable with the voice application for receiving the text document from the voice application and then modifying the text document as a function of a context of the text document. A TTS converter is operable with the text cleaner for converting the modified text document into speech. The TTS converter is operable for providing the speech to the telephone user via the voice application in order to satisfy the request for information from the telephone user. The communication system may further include a context detector operable for detecting the context of the text document. The context detector is operable with the text cleaner for providing information indicative of the context of the text document to the text cleaner.

The text document may include a marked-up language tag. The text cleaner is operable for processing the marked-up language tag for determining the context of the text document. The voice application may be operable for indicating the content of the text document to the text cleaner.

The text data source may be located on the Internet. The text data source may be email provider and the text document is an email text document. The text data source may also be a sports content provider, a weather content provider, a stock quote content provider, a news content provider, and the like.

The request from the telephone user may be an audio request and the voice application is operable for converting the audio request into a text request in order to retrieve a text document related to the information requested by the telephone user. The request from the telephone user may be a dual tone multi-frequency request and the voice application is operable for converting the dual tone multi-frequency request into a text request in order to retrieve a text document related to the information requested by the telephone user.

The advantages of the present invention are numerous. For example, the present invention includes a unique filtering system to modify written text based on its context prior to the text being synthesized by a TTS engine into speech. The result is a higher quality, smoother, more naturally flowing speech pattern produced by a TTS engine which is critical for wider acceptance of voice-computer interfaces.

The above objects and other objects, features, and advantages of the present invention are readily apparent from the following detailed description of the best mode for carrying out the present invention when taken in connection with the accompanying drawings.

### BRIEF DESCRIPTION OF DRAWINGS

FIG. 1 illustrates a block diagram of a communication system in accordance with a preferred embodiment of the present invention; and

FIG. 2 illustrates a flowchart describing operation of a text-to-speech conversion method and system in accordance with a preferred embodiment of the present invention.

### BEST MODE FOR CARRYING OUT THE INVENTION

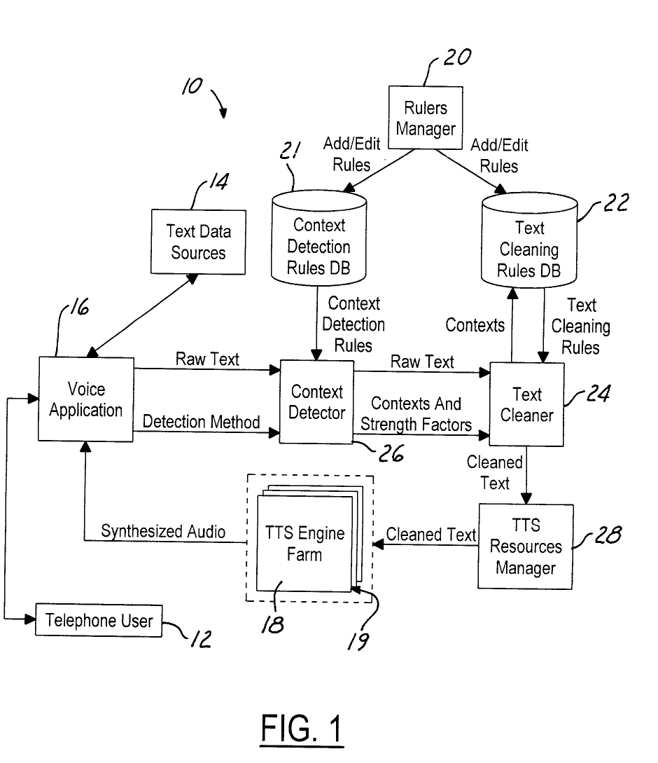

Referring now to FIG. 1, a block diagram of a communication system 10 in accordance with a preferred embodiment of the present invention is shown. Communication system 10 is a voice portal platform for enabling a telephone user 12 to access written text such as email, news, weather conditions, sport scores, stock quotes, and other information from text data sources 14. In response to a request for text or information from telephone user 12, communication system 10 locates and converts the requested text into speech and then provides the speech to the telephone user via a voice application 16. Telephone user 12 may be a wired or wireless telephone user and text data sources 14 may include text data sources such as the Internet and text data source providers such as email providers, news providers, weather condition providers, sport scores providers, stock quotes providers, and other text data storage networks.

The request for information from telephone user 12 to voice application 16 may be performed by the telephone user speaking an audible request or using digital signaling such as dual tone multi-frequency (DTMF) touch tone dialing. In response to an audible text request from telephone user 12, voice application 16 uses automatic speech recognition capability for understanding the audible text request. Similarly, voice application 16 is functional to understand a DTMF text request from telephone user 12. In response to a text or information request, voice application 16 accesses text data sources 14 to find text satisfying the request. For example, telephone user 12 may request a weather report for a particular city. In response to this request, voice application 16 accesses text data sources 14 to find a text document having the weather report for the particular city. Voice application 16 then receives an electronic copy of the weather report text from a text data source 14. As will be described in greater detail below, a TTS engine 18 of a TTS engine farm 19 in communication system 10 converts or synthesizes the weather report text from voice application 16 into computer generated audio speech. TTS engine 18 then provides the audio speech of the weather report text to telephone user 12 via voice application 16.

As described above, a problem with prior art communication systems having TTS engines is that the TTS engines are configured to convert text into speech without knowing the context of the text. Accordingly, communication system 10 includes elements for preprocessing the text prior to the text being sent to TTS engine 18 for synthesis into speech. The preprocessing elements of communication system 10 process the text to determine the context of the text, i.e., context detection, and then modify the text based on the context of the text, i.e., text cleaning. The preprocessing elements of communication system 10 then provide the modified text to TTS engine 18 for conversion into speech. As a result, TTS engine 18 synthesizes or converts the text into audio speech as a function of the context of the text. The resulting speech generated by TTS engine 18 has a higher quality, smoother, and more naturally flowing speech pattern than the speech pattern of speech generated by a TTS engine without knowledge of the context of the text.

The preprocessing elements of communication system 10 include a rules manager 20, a context detection rules database 21, a text cleaning rules database 22, a text cleaner or normalizer 24, and a context detector 26. Rules manager 20 allows administrators of communication system 10 to generate and associate rules for both context detection and text cleaning preprocessing. Context detection database 21 stores the context detection rules and text cleaning database 22 stores the text cleaning rules.

A context detection rule set includes a set of rules such as key words and phrases associated with a text context. Context detection database 21 stores many different context detection rule sets and each context detection rule set is associated with a unique text context. Context detector 26 accesses context detection rules database 21 to use the context detection rules to search the text for key words and phrases associated with each context detection rule set in order to determine the context of the text.

A text cleaning rule set provides instructions to text cleaner 24 on how to modify or change the text. Text cleaner 24 modifies specific words, phrases, abbreviations, acronyms, and pronunciation in the text in accordance with a text cleaning rule set to modify the text so that the modified text sounds natural when converted into speech. Each text cleaning rule set is associated with a unique text context. Text cleaner 24 modifies the text using the rules of a text cleaning rule set associated with the context of the text. Context detector 26 provides text cleaner 24 with an indication of the context of the text so that the text cleaner knows which text cleaning rules to use for modifying the text. In response to the indication of the context of the test, text cleaner 24 accesses text cleaning rules database 22 to obtain the text cleaning rules associated with the context of the text. Text cleaner 24 then applies the text cleaning rules at run-time to replace, modify, clean, or otherwise change the text before it is synthesized by TTS engine 18 into speech. Global text cleaning rules which apply to all text processed by text cleaner 24 may also be created using rules manager 20.

Context detection rules and text cleaning rules include thematic, cultural, regional, industry specific, and other types of rules. Additionally, rules manager 20 may add TTS engine specific text cleaning rules to text cleaning rules database 22 to handle differences between different types of TTS engines.

In operation, context detector 26 is operable with voice application 16 to receive an electronic copy of the text document obtained from text data source 14 in response to a request for information from telephone user 12. This electronic copy of the text document provided by voice application 16 to context detector 26 is labeled “Raw Text” in FIG. 1 as the text of the document obtained from text data source 14 has not been processed. Context detector 26 processes the raw text to determine the context of the text by locating in the text key words and phrases associated with each context detection rule set stored in context detection rules database 21.

For example, the context of the text may pertain to baseball and a context detection rule set may include key baseball words and phrases such as “baseball”, “home run”, “strike out”, and the like. If the text of the document contains any of these baseball words and phrases associated with the baseball context detection rule set then context detector 26 determines that the context of the text is baseball. Context detector 26 then provides an indication of the context of the text to text cleaner 24. In this case, the context indication indicates that the context of the text is baseball. Text cleaner 24 then accesses the baseball text cleaning rules from text cleaning rules database 22 and modifies the raw text in accordance with the baseball text cleaning rules.

Specifically, upon determining the context of the text, context detector 26 transfers the raw text and an identifier identifying the context of the text to text cleaner 24. The information transferred by context detector 26 to text cleaner 24 is labeled as “Raw Text” and “Contexts and Strength Factors” as shown in FIG. 1. The “Contexts” is an indicator of the contexts of the text. As described in greater detail below, the text may have many different contexts and context detector 26 is operable for determining each context of the text. For each determined context, context detector 26 is operable for determining a strength factor indicative of how well the text matched the context detection rule set for a particular context. The strength factor is combined with a weighted priority level as specified by rules manager 20.

Upon receiving the raw text and a context identifier from context detector 26, text cleaner 24 accesses text cleaning rules database 22 to access the text cleaning rules associated with a context of the text. Text cleaner 24 then replaces, modifies, or otherwise changes the raw text in accordance with the text cleaning rules to produce “Cleaned Text” as shown in FIG. 1. For example, if the context of the document is baseball, then text cleaner 24 uses the baseball context rules to convert the raw text into cleaned text. As an example of the conversion of the raw text into cleaned text the raw text may include “HR” and “SO”. Text cleaner 24 applies the baseball context rules to the raw text and converts the raw text “HR” and “SO” into the cleaned text “home run” and “strike out”.

Text cleaner 24 then provides the cleaned text to a TTS resource manager 28 which directs the cleaned text to an appropriate TTS engine 18 in TTS engine farm 19 for conversion or synthesis into speech. TTS resource manager 28 distributes the cleaned text to the appropriate TTS engine 18 based on the language of the text and the current workload of the TTS engines in the TTS engine farm. TTS engine 18 then converts the cleaned text into speech and provides the speech which is labeled “Synthesized Audio” in FIG. 1 to voice application 16. Voice application 16 then forwards or streams the speech to telephone user 12 in order to satisfy the information request from the telephone user.

As another example, the raw text provided to text cleaner 24 may include names of baseball players which are difficult to pronounce and cannot be easily translated into speech such as the names “Parque”, “Fontes”, and “Kallis”. An administrator may use rules manager 20 to generate and associate baseball context rules having the correct phonetic pronunciation of baseball player names with the baseball text cleaning rules stored in text cleaning rules database 22. Text cleaner 24 then converts the raw text having baseball player names into cleaned text having the correct phonetic pronunciation in accordance with the baseball text cleaning rules. For instance, text cleaner 24 converts the raw text “Fontes”, “Parque”, and “Kallis” to the cleaned text “phon-te”, “park”, and “ka-lis”, respectively, in accordance with the baseball text cleaning rules. TTS engine 18 then converts the cleaned text of the baseball player's names into speech having the correct pronunciation.

Additionally, as mentioned above, text documents may have multiple contexts or themes. The text documents may have a dominant theme and perhaps a number of sub-themes in some sort of priority order. For example, in a news story about a baseball player recovering from an injury, the dominant theme may be baseball and a sub-theme may be medicine. In this example, context detector 26 would process the raw text to determine the contexts of the text and would locate baseball and medicine key words and phrases. As the dominant theme of the text is baseball, the text would probably include more baseball key words than medicine key words. Context detector 26 preferably prioritizes the contexts of the text in accordance with the number of key words located in the text combined with a weighted priority level as specified by rules manager 20. Context detector 26 then identifies the text as having a dominant baseball theme and a medicine sub-theme. Context detector 26 then transfers the raw text to text cleaner 24 along with a primary context identifier identifying the primary context of the text as being related to baseball and a secondary context identifier identifying a secondary context of the text as being related to medicine. The primary context identifier may include a strength factor having a higher strength factor than the secondary content identifier so that text cleaner 24 knows which context is the primary context and which context is the secondary context.

In response, text cleaner 24 first modifies the raw text in accordance with the baseball text cleaning rules and then modifies the raw text in accordance with the medicine text cleaning rules in order to produce cleaned text. TTS engine 18 then converts the cleaned text into speech.

In addition to context detector 26 detecting the context of the text, communication system 10 is operable in two additional detection methods for detecting the context of the text. Each of these two additional detection methods do not use context detector. The first additional detection method is performed by having voice application 16 directly indicate the context(s) of the text to text cleaner 24. In this case, voice application 16 knows the context of the text and indicates to text cleaner 24 which text cleaning rules to access in order to modify the text. Voice application 16 may know the context of the text by determining the context of the request information from telephone user 12.

The second additional detection method is performed by embedding marked-up language tags in the text. A writer of the text may embed marked-up language tags within a text document at specific locations in the text document prior to making the text available in a text data source 14. This allows contexts to be applied to specific parts of a text document. Text cleaner 24 is operable to process the text to locate the embedded marked-up language tags to determine the contexts of the text. Of course, context detector 26 is also operable to process the text to locate the embedded marked-up language tags to determine the contexts of the text. Once the contexts of the text are identified, then text cleaner 24 accesses the required text cleaning rules to apply the appropriate text cleaning rules to the text or parses the marked-up tags for modifying the text. If different contexts are identified in different sections of the text document, text cleaner 24 may modify one section of the text document in accordance with the text cleaning rules associated with the context of this section and modify another section of the text document in accordance with the text cleaning rules associated with the context of that section.

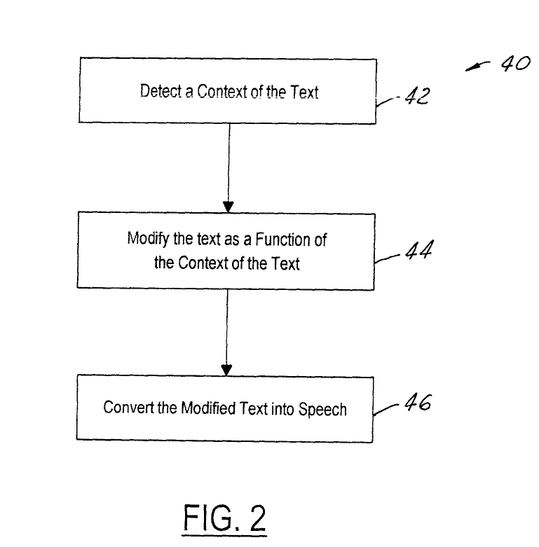

Referring now to FIG. 2, with continual reference to FIG. 1, a flowchart 40 describing operation of the text-to-speech conversion method and system in accordance with a preferred embodiment of the present invention is shown. Flowchart 40 begins with detecting a context of the text as shown in box 42. The context of the text may be detected by context detector 26 locating key words and phrases in the text. Voice application 16 may indicate the context of the text or the text may have marked-up language tags indicating the context of the text in specific locations within the text. The text is then modified by text cleaner 24 as a function of the context of the text as shown in box 44. The modified text is then converted into speech by TTS engine 18 as shown in box 46.

Thus it is apparent that there has been provided, in accordance with the present invention, a text-to-speech method and system which convert written text into audible speech as a function of the context of the text that fully satisfies the objects, aims, and advantages set forth above. The present invention has been described in the context of converting English text into speech. As evident to one of ordinary skill in the art, the present invention is also applicable for converting text written in any language into speech. For example, the present invention may convert text written in French into French speech. To this end, context detector 26 is able to detect the language of the test so that text cleaner 24 applies the correct text cleaning rules to the text. An appropriate language-specific TTS engine 18 then converts the cleaned text into speech. While the present invention has been described in conjunction with specific embodiments thereof, it is evident that many alternatives, modifications, and variations will be apparent to those skilled in the art in light of the foregoing description. Accordingly, it is intended to embrace all such alternatives.

What is claimed is:

1. A system for converting text into speech, the system comprising:
a text cleaner operable for modifying text as a function of a context of the text; and
a text-to-speech converter operable with the text cleaner for converting the modified text into speech.

2. The system of claim 1 further comprising:
a context detector operable for detecting the context of the text, wherein the context detector is operable with the text cleaner for providing information indicative of the context of the text to the text cleaner.

3. The system of claim 2 further comprising:
a context detection rules database operable for storing context detection rule sets, each context detection rule set associated with a context, wherein the context detector is operable with the context detection rules database for applying the context detection rule sets to the text in order to detect the context of the text.

4. The system of claim 3 further comprising:
a rules manager operable for enabling an administrator to generate context detection rule sets, wherein the rules manager is operable with the context detection rules database for storing the generated context detection rule sets in the context detection rules database.

5. The system of claim 3 further comprising:
a text cleaning rules database operable for storing text cleaning rule sets each associated with a context, wherein the text cleaner is operable with the text cleaning rules database for accessing the text cleaning rule sets in order to modify the text in accordance with the text cleaning rule sets associated with the context of the text.

6. The system of claim 5 further comprising:
a rules manager operable for enabling an administrator to generate text cleaning rule sets, wherein the rules manager is operable with the text cleaning rules database for storing the generated text cleaning rule sets in the text cleaning rules database.

7. The system of claim 1 wherein:
the text cleaner is operable for modifying the text as a function of multiple contexts of the text.

8. A method for converting text into speech, the method comprising:
(I) detecting a context of the text;
(II) modifying the text as a function of the context of the text; and
(III) converting the modified text into speech.

9. The method of claim 8 further comprising:
(IV) storing context detection rule sets each associated with a context, wherein step (I) includes applying the context detection rule sets to the text in order to detect the context of the text.

10. The method of claim 9 wherein:
step (IV) includes enabling an administrator to generate context detection rule sets for storage.

11. The method of claim 9 further comprising:
(V) storing text cleaning rule sets each associated with a context, wherein step (II) includes accessing the text cleaning rule sets in order to modify the text in accordance with the text cleaning rule sets associated with the context of the text.

12. The method of claim 11 wherein:
step (V) includes enabling an administrator to generate text cleaning rule sets for storage.

13. The method of claim 8 wherein:
step (I) includes detecting multiple contexts of the text and step (II) includes modifying the text as a function of the multiple contexts of the text.

14. A communication system for communicating information to a telephone user in response to a request for the information from the telephone user, the system comprising:
a text data source having a plurality of text documents;
a voice application operable with the telephone user for receiving a request from the telephone user for information, wherein the voice application is operable with the text data source for retrieving a text document related to the information requested by the telephone user;
a text cleaner operable with the voice application for receiving the text document from the voice application and then modifying the text document as a function of a context of the text document;
a text-to-speech converter operable with the text cleaner for converting the modified text document into speech, wherein the text-to-speech converter is operable for providing the speech to the telephone user via the voice application in order to satisfy the request for information from the telephone user.

15. The system of claim 14 further comprising:
a context detector operable for detecting the context of the text document, wherein the context detector is operable with the text cleaner for providing information indicative of the context of the text document to the text cleaner.

16. The system of claim 14 further comprising:
a context detection rules database operable for storing context detection rule sets, each context detection rule set associated with a context, wherein the context detector is operable with the context detection rules database for applying the context detection rule sets to the text document in order to detect the context of the text document.

17. The system of claim 16 further comprising:
a rules manager operable for enabling an administrator to generate context detection rule sets, wherein the rules manager is operable with the context detection rules database for storing the generated context detection rule sets in the context detection rules database.

18. The system of claim 16 further comprising:
a text cleaning rules database operable for storing text cleaning rule sets each associated with a context, wherein the text cleaner is operable with the text cleaning rules database for accessing the text cleaning rule sets in order to modify the text document in accordance with the text cleaning rule sets associated with the context of the text document.

19. The system of claim 18 further comprising:
a rules manager operable for enabling an administrator to generate text cleaning rule sets, wherein the rules manager is operable with the text cleaning rules database for storing the generated text cleaning rule sets in the text cleaning rules database.

20. The system of claim 14 wherein:
the text cleaner is operable for modifying the text document as a function of multiple contexts of the text document.

21. The system of claim 14 wherein:
the text document includes a marked-up language tag, wherein the text cleaner is operable for processing the marked-up language tag for determining the context of the text document.

22. The system of claim 14 wherein:
the voice application is operable for indicating the content of the text document to the text cleaner.

23. The system of claim 14 wherein:
the text data source is located on the Internet.

24. The system of claim 14 wherein:
the text data source is an email provider and the text document is an email text document.

25. The system of claim 14 wherein:
the text data source is a content provider.

26. The system of claim 25 wherein:
the content provider is a sports content provider.

27. The system of claim 25 wherein:
the content provider is a weather content provider.

28. The system of claim 25 wherein:
the content provider is a stock quote content provider.

29. The system of claim 25 wherein:
the content provider is a news content provider.

30. The system of claim 14 wherein:
the request from the telephone user is an audio request, wherein the voice application is operable for converting the audio request into a text request in order to retrieve a text document related to the information requested by the telephone user.

31. The system of claim 14 wherein:
the request from the telephone user is a dual tone multi-frequency request, wherein the voice application is operable for converting the dual tone multi-frequency request into a text request in order to retrieve a text document related to the information requested by the telephone user.
